(19) United States
(12) Patent Application Publication
(10) Pub. No.: US 2022/0016447 A1
(43) Pub. Date: Jan. 20, 2022

(54) Powered Air-Purifying Respirator

(71) Applicant: Jennifer A. Delaney, St. Louis, MO (US)

(72) Inventor: Jennifer A. Delaney, St. Louis, MO (US)

(21) Appl. No.: 17/233,638

(22) Filed: Apr. 19, 2021

Related U.S. Application Data
(60) Provisional application No. 63/051,571, filed on Jul. 14, 2020.

(51) Int. Cl. A62B 7/10; A62B 18/00; A62B 23/02; A62B 9/00; A62B 7/12

(52) U.S. Cl. CPC A62B 7/10; A62B 18/006; A62B 7/12; A62B 9/006; A62B 9/00; A62B 23/02

(57) ABSTRACT

A powered air-purifying respirator has a blower unit with an inlet and an outlet. The blower unit draws air through the inlet and out of the outlet. A filter assembly is removably connected on the outlet end of the blower unit. The filter assembly has a first end and a second end. The first end is removably connected to the outlet of the blower unit, and the second end of the filter assembly is adapted and configured to be coupled to a breathing hose.

### RELATED APPLICATION DATA

This application is a non-provisional application which claims the benefit of provisional U.S. application No. 63/051,571, filed on Jul. 14, 2020, the disclosures of which are incorporated by reference herein.

### BACKGROUND AND SUMMARY

This disclosure pertains to powered air-purifying respirators. More particularly, the present disclosure pertains to powered air-purifying respirators with a removable filter assembly on the outlet end of a blower unit. The removable filter assembly on the outlet end of the blower is particularly useful in the healthcare setting.

### BRIEF DESCRIPTION OF THE DRAWINGS

FIG. 1 is an exploded schematic view of an exemplary powered air-purifying respirator.

FIG. 2A is a partial view of the exemplary powered air-purifying respirator of FIG. 1 showing a blower unit, filter assembly and battery assembly with a slot and pin connection of the filter assembly and blower unit.

FIG. 2B is a partial view of the exemplary powered air-purifying respirator of FIG. 1 showing a blower unit, filter assembly and battery assembly with a magnetic sensor connection of the filter assembly and blower unit.

FIG. 3A is a front view of an interior of the blower unit with a pin connection at the connection of the filter assembly (not shown) to blower unit.

FIG. 3B is a front view of an interior of the blower unit with a Hall effect sensor at the connection of the filter assembly (not shown) to the blower unit.

FIG. 4 is a bottom view of the blower unit.

FIG. 5A is a side view of the filter assembly with a removable filter element and a slot arrangement at the connection of the filter assembly to the blower unit (not shown).

FIG. 5B is a side view of the filter assembly with an integral filter element and a magnet arrangement at the connection of the filter assembly to the blower unit (not shown).

FIG. 6 is a perspective view of a battery holster of the powered air-purifying respirator.

FIG. 7 is a perspective view of a battery of the powered air-purifying respirator

FIG. 8 is a process flow diagram of a sensor and a processor of the powered air-purifying respirator.

FIG. 9 is an exploded schematic view of another embodiment of a powered air-purifying respirator.

### DETAILED DESCRIPTION

Powered air-purifying respirator hoods and respirators have been critical for the protection of the health care workforce during the COVID-19 pandemic. Powered air-purifying respirator systems provide the wearer respiratory protection against COVID-19, while also increasing comfort and decreasing the need for the mask-type personalized fit.

The drawings show an exemplary powered air-purifying respirator that includes a hood with a connection to a respiratory assembly. The respiratory assembly includes a blower unit, a filter assembly located on the outflow of the blower unit, a battery, belt/buckles, and a breathing hose that is adapted and configured to be connected with the hood.

The exemplary powered air-purifying respirator shown in the drawings differs from traditional industrial powered air-purifying respirators in that it is designed for healthcare use rather than for use with poisonous gases or highly particulate environments, like welding, asbestos work, silica and pharmaceutical manufacturing. The exemplary powered air-purifying respirator includes a mechanical filter that is on the outflow of the blower motor rather than on the intake side. This allows for easy filter replacement in highly infectious environments. The filter and filter casing may be integrated into the breathing hose, and the filter may be adapted and configured to be replaced by the end user. The breathing hose may be releasably connected to a mask, hood or head piece, which are well known in the art. The hose and filter may be changed by the end user as often as desired. The hose and filer may be discarded after a single use. The filter and hose may be used for an extended period of time. The filter may be discarded after a single use while the breathing hose is used for an extended period of time. For instance, the filter may be useable for a month before replacement, and the hose may be sanitized or sterilized and reused with a new filter.

Further, by placing the filter on the breathing hose on the outflow side of the blower unit, the filter may act as a check valve to prevent the back flow of contamination into the blower unit. This allows the hood and breathing hose to be used by the same user while allowing the blower unit to be used by multiple users with reduced risk of cross contamination. This increases operational flexibility in that blowers may be changed out and recharged as necessary with reduced risk of cross contamination. The hood may be sanitized as necessary and the hose with the filter may be discarded, while the blower units may be kept operationally ready for use for multiple users.

The exemplary powered air-purifying respirator also may include a pressure sensor alarm that senses decreased output pressure from the blower which may be caused by an obstruction in the breathing hose. In conventional powered air-purifying respirators, the sensor senses low pressure from the intake side of the blower unit that is caused by an obstruction at the intake which is many times caused by a filter clogged with particulate matter. The exemplary powered air-purifying respirator locates the sensor on the discharge side of the blower unit to provide the user with a more responsive indication that purified air flow to the hood may be disrupted.

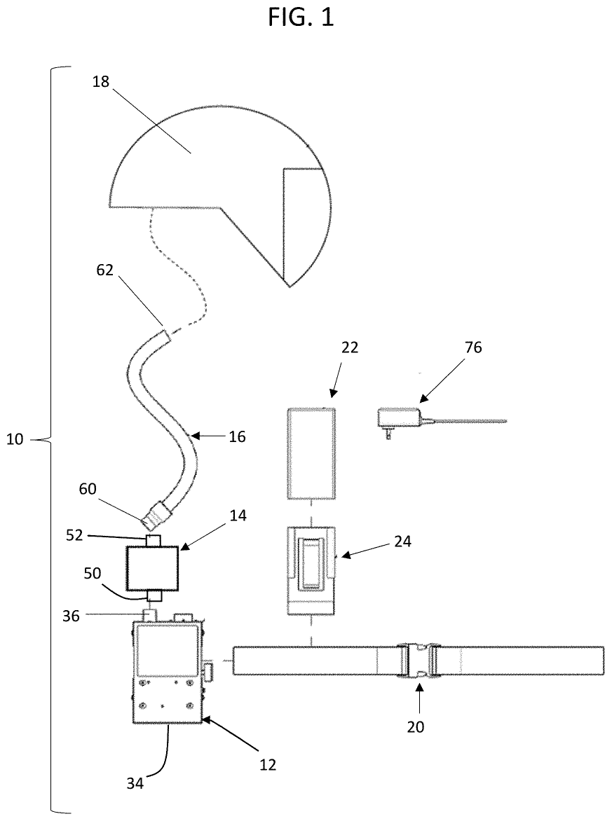

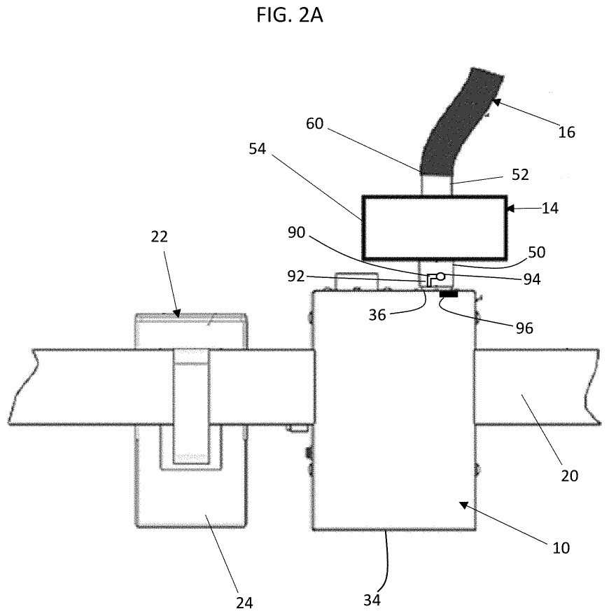

FIGS. 1, 2A and 2B provide examples of embodiments of the powered air-purifying respirator 10. The powered air-purifying respirator 10 comprises a blower unit 12, a filter assembly 14, a breathing hose 16 and a mask/hood 18. The power air-purifying respirator 10 may further include a belt 20 to allow the user to comfortably use the power air-purifying respirator. A battery 22 and holster 24 may be mounted on the belt to further facilitate use of the power air-purifying respirator.

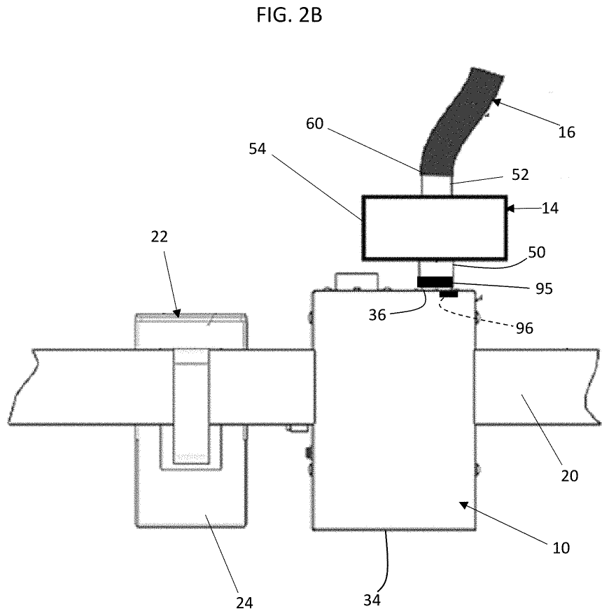

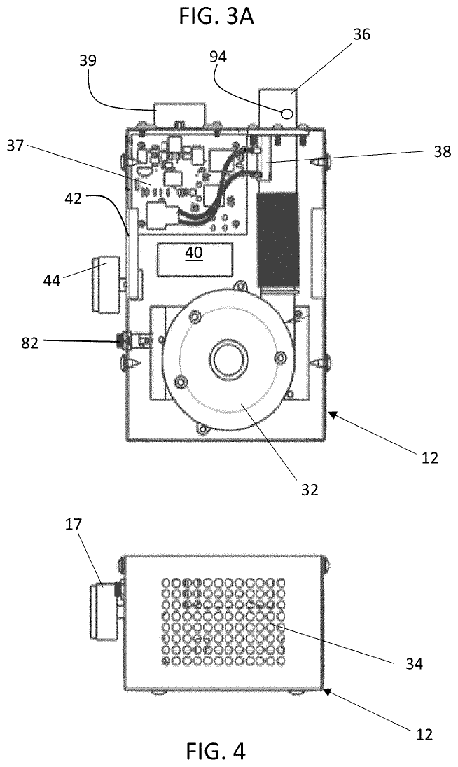

Making reference to FIGS. 3A, 3B and 4, the blower unit 10 includes a housing with an interior. A centrifugal fan 32 may be mounted within the housing and arranged to draw ambient air through an inlet 34 at the bottom of the blower unit housing and discharge pressurized air through an outlet 36 at the top of the blower unit housing. Within the housing, the blower unit 12 may include operational and control circuitry 37 and a discharge pressure sensor 38 for operation of the powered air purifying respirator. The discharge pressure sensor 38 may comprise a venturi tube and associated tubing for measuring the air pressure generated by the fan 32. The control circuitry may be enabled to generate an alarm when discharge pressure decreases below an acceptable threshold. The alarm may be visual through a light on the exterior of the housing of the blower unit. The alarm may be audible via buzzer 39 on the exterior of the housing. Control circuitry 37 may also be adapted and configured with a fan speed control 40 that receives input from a potentiometer 42 to control the speed of the fan 32. A control knob 44 for the potentiometer disposed on the outside of the housing to facilitate user control of air pressure.

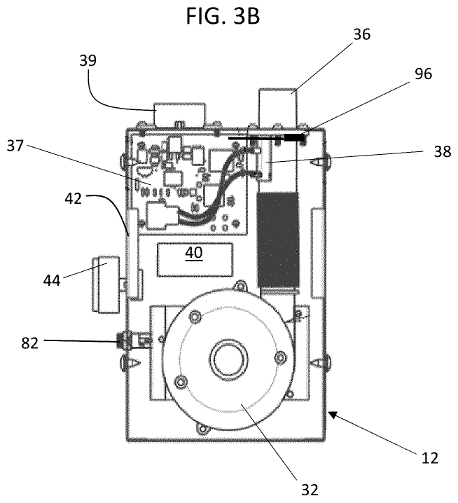

Making reference to FIGS. 5A and 5B, the filter assembly 14 may be provided at the outlet 36 of the blower unit 12. The filter assembly 14 may comprise a first end 50, which may be removably connected at the outlet 36 of the housing, and a second end 52, which may be removably connected to the breathing hose 16. The filter assembly 14 may include a casing 54 which contains a filter 56. The filter 56 may be a 0.03 micron HEPA filter. The filter 54 may fit in the casing in a unique manner to orient the filter in the casing between the first and second ends in the direction of air flow so as to maximize the effectiveness of the filter. In one example as shown in FIG. 5A, the filter 56 may be removably installed within the filter casing 54. Providing a removable filter in the casing allows the user the ability to change the filter as needed after a certain period of use. In another example as shown in FIG. 5B, the filter may be integral with the filter casing. The removable connections of the first and second ends 50,52 of the filter assembly 14 with the blower unit 12 and the breathing hose 16, respectively, allow the filter assembly to be changed by the user as necessary and/or assigned to a particular user independently of the mask/hood, breathing hose and blower unit.

The breathing hose 16 may extend from the filter assembly second end 52 to the hood or mask 18. The breathing hose 16 may have a length with opposite first and second ends 60,62. The breathing hose first end 60 may be adapted and configured to be removably connected with the filter assembly second end 52, and the breathing hose second end 62 may be adapted and configured to be removably connected with the hood or mask 18. In one aspect, the breathing hose may be 19 mm polyethylene hose with a length of about 3 feet. The removable connections of the first and second ends of the breathing hose 60,62 with the filter assembly 14 and mask/hood 18 may be a screw/union, compression, expansion, clamps, and/or press fit type connection or other known ways of removably connecting flexible tubing. The removable connections of the first and second ends of the breathing hose 60,62 with the filter assembly 14 and mask/hood 18, respectively, allow the breathing hose 16 to be changed by the user as necessary and/or assigned to a particular user, independently of the mask/hood, filter assembly and blower unit.

The discharge pressure sensor 38 may be arranged within the housing of the blower unit at the outlet 36 of the blower unit 12, and may be adapted and configured to activate an alarm when the pressure sensor senses decreased pressure or air flow from the blower unit 12. The pressor sensor 38 may be positioned at the outlet 36 of the blower unit so as to measure the air pressure inside the breathing hose 16. Thus, if there is an obstruction in the breathing hose 16, the breathing hose may be replaced.

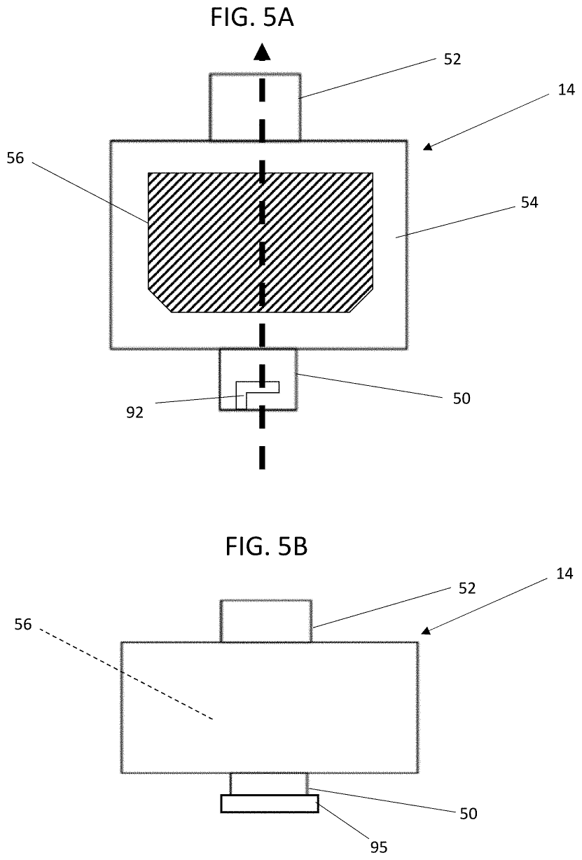

The belt 20 of the powered air-purifying respirator may be coupled to the blower unit 12 and the battery holster 24. The belt 20 allows the powered air-purifying unit to wrap around the waist of a user and stay in place. The belt 20 may be connected by any standard fastener or buckle known in the art. The battery 22 of the powered air-purifying unit may be coupled to the holster 24 in proximity to the blower unit 12 to provide power to the blower unit. The battery holster 24 may be configured in any way to receive the battery 22. As shown in FIG. 6, the battery holster 24 includes left and right opposite side clips 70,72 and a bottom panel 74 that releasably receive the battery 22 in the holster. The battery 22 may be adapted and configured to receive a battery charger 76 (FIG. 1), thereby allowing the battery to be recharged as necessary for multiple uses. The battery 22 may be configured with have a battery switch 78 so when the battery is electrically coupled to the blower unit 12, the blower unit may be turned on and off with the switch on the battery. The battery 22 may also have ports 80 which allow the battery to be connected to the blower unit 12 (see, e.g., connection port ‘82’ (FIGS. 3A,3B)) as well as connected to an external power source, such as the battery charger 76.

The powered air-purifying unit 10 may be adapted to ensure the filter assembly 14 is correctly installed on the blower unit 12. By way of example and not in any limiting sense, for instance, as shown in FIGS. 2A, 3A, and 5A, the filter assembly may have a keyed arrangement 90 with the blower unit 12 to allow the first end 50 of the filter assembly to be removably connected to the blower unit in a correct orientation. In one aspect, the keyed arrangement 90 may comprise a set of cooperating pins and slots on the first end 50 of the filter assembly and the outlet 36 of the blower unit that allow the filter assembly to be assembled with outlet of the blower unit in only one way thereby ensuring the filter assembly is installed correctly on the outlet of the blower assembly. By way of example and not in any limiting sense, as shown in FIGS. 2A, 3A, and 5A, the first end 50 of the filter assembly may have a slot 92 that extends axially and circumferentially about the first end, and the outlet 36 of the blower unit may be formed with a pin 94 that is dimensioned to slide in the slot. To install the filter assembly 14 at the outlet 36 of the blower unit 12, the filter assembly may be arranged so the slot 92 of the first end 50 of the filter assembly receives the pin 94. The filter assembly 14 may pushed together with the blower unit 12 and rotated relative to the blower unit to engage the filter assembly on the outlet of the blower unit. The keyed arrangement 90 may be arranged as necessary to allow the filter assembly 14 and the blower unit 12 to connect in the correct orientation. Other connections including an offset geometry connection, bayonet connection, press fit connection, etc. may be used.

In addition or in the alternative to the aforementioned keyed arrangement or locking clip arrangement to ensure the filter assembly 14 is correctly installed on the blower unit 12, the filter assembly may be provided with a magnet 95 on its distal end of the first end 50 of the filter assembly, and a Hall effect sensor (or proximity sensor) 96 may be provided on the blower unit outlet 36 or within the blower unit housing adjacent the blower unit outlet as shown in FIGS. 2B, 3B and 5B. When the first end 50 of the filter assembly is properly seated on the blower unit outlet 36, the magnet 95 may activate the sensor 96 to allow the blower unit fan 32 to be energized. The Hall effect sensor 96 may also be enabled to be actuated when a filter 56 is installed in the filter casing 54 and/or when the filter is oriented correctly in the filter casing (in the case of a filter removably installed in the casing). The Hall effect sensor 96 may be adapted and configured to generate an activation signal to allow activation of the blower unit 12 only when the first end 50 of the filter assembly 14 is removably connected to the outlet 36 of the blower unit 12 correctly, when a filter 56 is installed in the filter casing 54, and/or when the filter is oriented correctly in the filter casing, as the case may be depending upon the nature of the filter assembly (in the case of an integral filter and filter casing, the magnet and sensor need not be so configured).

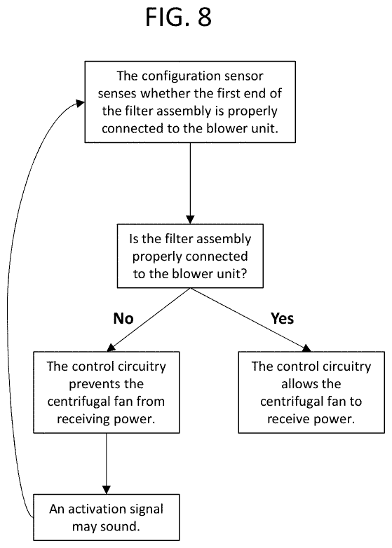

FIG. 8 shows an exemplary schematic of how the magnet 95 and Hall effect sensor 96 and the control circuitry 37 allow for operation of the blower unit 12 when the filter assembly 14 is installed correctly. The Hall effect sensor 96 first senses whether the first end 50 of the filter assembly 14 is properly seated on the outlet 36 of the blower unit and/or other properly connected to the blower unit 12. Depending upon the configuration of the filter, the Hall effect sensor may also be configured to sense whether a filter is installed in the filter casing and whether oriented in the correct manner within the filter casing, as discussed above. The proper connection allows for air to flow between the blower unit 12 and the filter assembly 14 and into the filter assembly in the correct orientation to maximize effectiveness of the filter and ensure sufficient air flow to the breathing tube 16 and hood/mask 18. If the control circuitry 37 determines that the filter assembly 14 is not properly connected to the blower unit 12, the control circuitry 37 prevents the centrifugal fan 32 from receiving power. In one aspect, the control circuitry 37 may emit an activation signal for instance a light on the exterior of the housing. The activation signal alerts the end user that the filter assembly 14 is improperly connected to the blower unit 12 and that the blower unit 12 will not receive power until the connection is secure. If the control circuitry 37 determines that the filter assembly 14 is properly connected to the blower unit 12, the control circuitry 37 allows the centrifugal fan 32 to receive power.

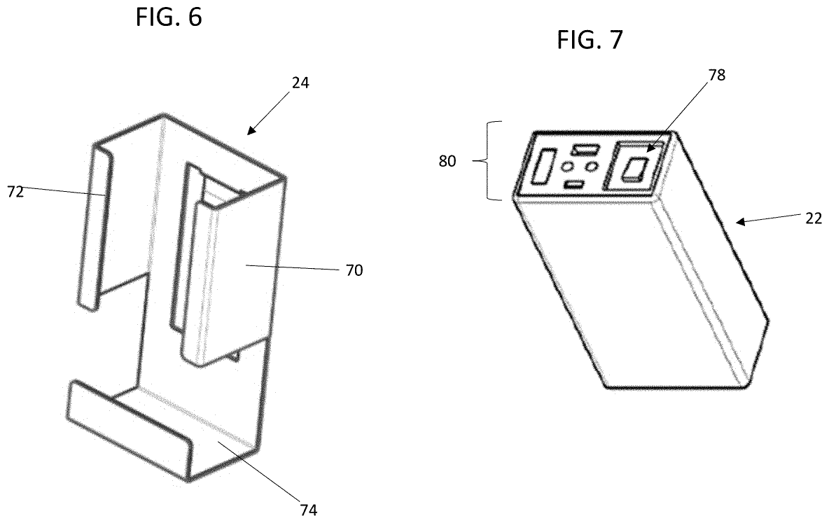

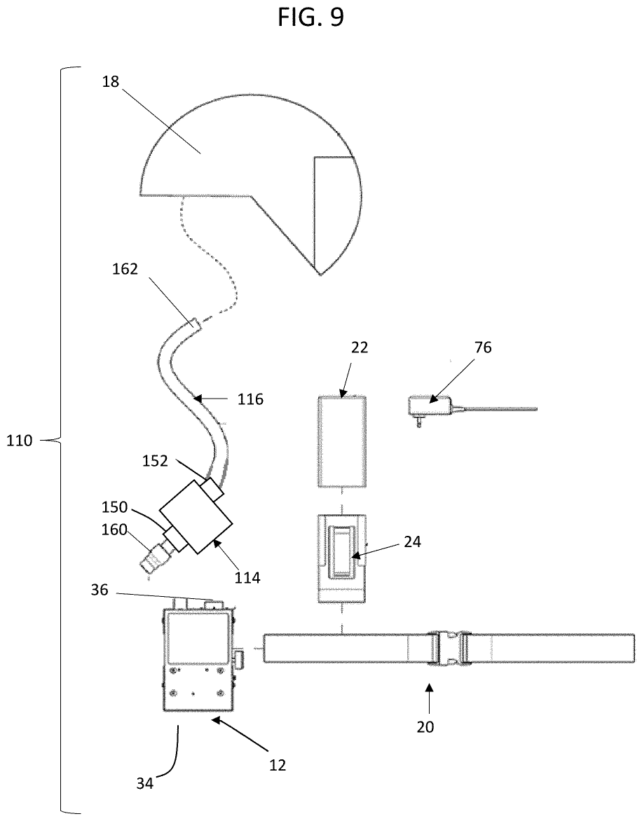

FIG. 9 shows another embodiment of the powered air-purifying respirator 110. In some respects, the elements of the embodiment of the powered air-purifier respirator of FIG. 9 are the same as shown in the embodiment disclosed and described in reference FIGS. 1-8, and for the sake of brevity will not be repeated. In the embodiment of the powered air-purifier respirator 110 of FIG. 9, the breathing hose 116 has first and second and 160,162, and the filter assembly 114 is disposed between the first and second ends of the breathing hose. The first end 160 of the breathing hose 160 may be mounted to the outlet 36 of the blower unit 12 in the manner described above in reference to FIGS. 1-8, and in particular, the first end 50 of the filter assembly being removably connected to the blower unit 12 with the keyed arrangement 90. In other words, the first end 160 of the breathing hose 116 may be adapted and configured to cooperate with the outlet 36 of the blower unit 12 to allow the breathing hose to be installed correctly on the outlet of the blower unit including having a magnetic material on its end 160 that enables a Hall effect sensor 96 to send signals to the control circuitry 37 of the blower unit 12 to allow the blower unit to be energized when the first end 160 of the breathing hose 116 is correctly installed and/or inserted in the unique and/or correct manner into the outlet 36 of the blower unit.

As various modifications could be made in the construction herein described and illustrated without departing from the scope of the invention, it is intended that all matter contained in the foregoing description or shown in the accompanying drawings shall be interpreted as illustrative rather than limiting.

Thus, the breadth and scope of the present invention should not be limited by any of the above-described exemplary embodiments, but should be defined only in accordance with the following claims appended hereto and their equivalents.

1. A powered air-purifying respirator comprising:
a blower unit comprising a fan with an inlet and an outlet, the blower unit being adapted and configured to draw air through the inlet with the fan and direct pressurized air from the fan out the outlet; and
a filter assembly comprising a first end and a second end, the first end of the filter assembly being removably connected to the outlet of the blower unit, the second end of the filter assembly being adapted and configured to be removably connected to a breathing hose.

2. The powered air-purifying respirator of claim 1, wherein the filter assembly comprises a filter encased in a filter casing.

3. The powered air-purifying respirator of claim 1, further comprising a pressure sensor at the outlet of the blower unit, the pressure sensor being adapted and configured to activate an alarm when the pressure sensor senses decreased output pressure from the blower unit.

4. The powered air-purifying respirator of claim 1, wherein the powered air-purifying respirator further comprises a belt coupled to the blower unit.

5. The powered air-purifying respirator of claim 4, wherein the powered air-purifying respirator further comprises a battery assembly coupled to the belt, the battery assembly providing power to the blower unit.

6. The powered air-purifying respirator of claim 5, wherein the battery assembly comprises a battery holster and a battery, the battery holster is coupled to the belt, the battery holster is configured to receive the battery.

7. The powered air-purifying respirator of claim 1, wherein the first end of the filter assembly and the blower outlet cooperate to generate a signal to activate the blower unit when the first end of the filter assembly is properly connected to the blower unit.

8. The powered air-purifying respirator of claim 7, wherein the first end of the filter assembly has a magnetic material, and the blower unit outlet has a Hall effect sensor that cooperates with the magnetic material to generate a signal to activate the blower unit when the first end of the filter assembly is properly connected to the blower unit.

9. A powered air-purifying respirator comprising:
a blower unit comprising a fan with an inlet and an outlet, the blower unit being adapted and configured to draw air through the inlet with the fan and direct pressurized air from the fan out the outlet; and
a filter assembly comprising a first end and a second end, the first end of the filter assembly being removably connected to the outlet of the blower unit, the second end of the filter assembly being adapted and configured to be removably connected to a breathing hose; and
a breathing hose comprising a first end and a second end, the first end of the breathing hose being adapted and configured to be removably connected to the second end of the filter assembly.

10. The powered air-purifying respirator of claim 9, wherein the filter assembly comprises a filter encased within a filter casing.

11. The powered air-purifying respirator of claim 9, further comprising a pressure sensor at the outlet of the blower unit, the pressure sensor being adapted and configured to activate an alarm when the pressure sensor senses decreased output pressure from the blower unit.

12. The powered air-purifying respirator of claim 9, wherein the powered air-purifying respirator further comprises a belt coupled to the blower unit.

13. The powered air-purifying respirator of claim 12, wherein the powered air-purifying respirator further comprises a battery assembly coupled to the belt, the battery assembly providing power to the blower unit.

14. The powered air-purifying respirator of claim 13, wherein the battery assembly comprises a battery holster and a battery, the battery holster is coupled to the belt, the battery holster is configured to receive the battery.

15. The powered air-purifying respirator of claim 9, wherein the first end of the filter assembly and the blower outlet cooperate to generate a signal to activate the blower unit when the first end of the filter assembly is properly connected to the blower unit.

16. The powered air-purifying respirator of claim 15, wherein the first end of the filter assembly has a magnetic material, and the blower unit outlet has a Hall effect sensor that cooperates with the magnetic material to generate a signal to activate the blower unit when the first end of the filter assembly is properly connected to the blower unit.

17. A powered air-purifying respirator comprising:
a blower unit comprising a fan with an inlet and an outlet, the blower unit being adapted and configured to draw air through the inlet with the fan and direct pressurized air from the fan out the outlet; and
a breathing hose having a length with a first end on one end of the length and a second end on an opposite end of the length, the breathing hose having a filter assembly intermediate of the first and second ends, the first end of the breathing hose being removably connected to the outlet of the blower unit.

18. The powered air-purifying respirator of claim 17, wherein the filter assembly comprises a filter encased within a filter casing.

19. The powered air-purifying respirator of claim 17, wherein the first end of the breathing hose and the blower outlet cooperate to generate a signal to activate the blower unit when the first end of the breathing hose is properly connected to the blower unit.

20. The powered air-purifying respirator of claim 19, wherein the first end of the breathing hose has a magnetic material, and the blower unit outlet has a Hall effect sensor that cooperates with the magnetic material to generate a signal to activate the blower unit when the first end of the breathing hose is properly connected to the blower unit.
